(19) United States
(12) Patent Application Publication
(10) Pub. No.: US 2013/0042860 A1
(43) Pub. Date: Feb. 21, 2013

(54) METHOD OF ISOLATING A BANANA STARCH FROM GREEN BANANAS

(71) Applicant: Michael Madson, Garner, IA (US)

(72) Inventor: Michael Madson, Garner, IA (US)

(21) Appl. No.: 13/366,908

(22) Filed: Feb. 6, 2012

Related U.S. Application Data
(60) Provisional application No. 61/523,917, filed on Aug. 16, 2011.

(51) Int. Cl. C08B 30/04

(52) U.S. Cl. 127/67

(57) ABSTRACT

A method for isolating banana starch from green bananas where the green banana is blended with a solution of sodium bisulfite and water. The liquid suspension of the resulting mixture is then centrifuged to separate the green material and the white banana starch. The white banana starch is then washed in a 95% ethanol to wash free the sodium bisulfite and isolate the banana starch.

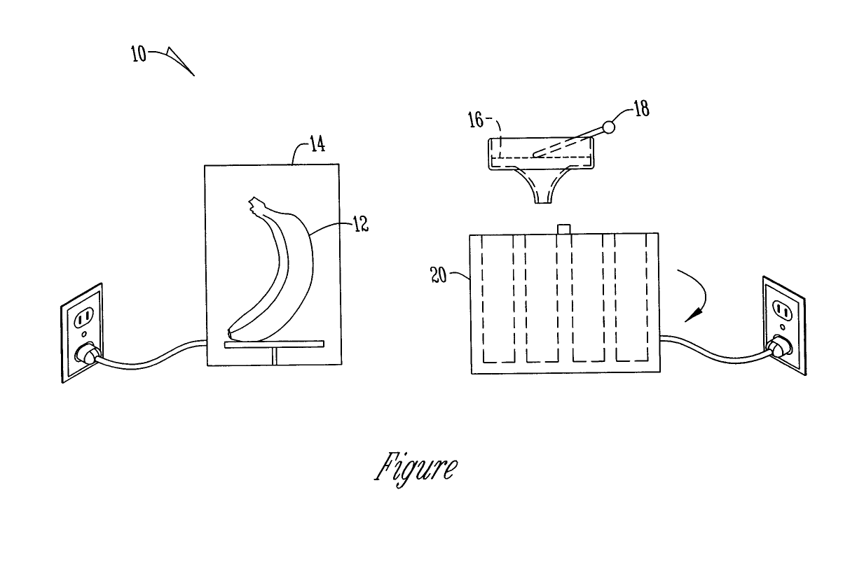

### CROSS REFERENCE TO RELATED APPLICATION

This application claims the benefit of U.S. Provisional Application No. 61/523,917 filed Aug. 16, 2011.

### BACKGROUND OF THE INVENTION

This invention relates to a method of isolation. More specifically, this invention relates to a method of isolation of banana starch from green bananas.

Currently potato starch is utilized in the preparation of many food products. There is a need in the art for a substitute for such potato starches, one of which is a banana starch. The problem in the art with retrieving banana starch is that a very low yield is presented when utilizing methods to extract the banana starch. Thus, a need in the art exists for an improved method of isolating banana starch from green bananas.

Therefore, a principal object of the present invention is to provide a method of isolating banana starch from green bananas.

### BRIEF SUMMARY OF THE INVENTION

A method of isolating banana starch from a green banana. The steps include blending a green banana with a treatment solution for a predetermined amount of time to create a mixture. The mixture is then poured through a sieve and a liquid suspension is collected to be placed in a centrifuge device. The liquid suspension is then centrifuged in order to form a white banana starch that is washed with ethanol in order to isolate the banana starch.

### BRIEF DESCRIPTION OF THE DRAWINGS

The FIGURE is a schematic diagram of an isolation system.

### DETAILED DESCRIPTION OF THE PREFERRED EMBODIMENT

The FIGURE shows an isolation system 10 for isolating starch from a green banana 12. This method involves preparing a solution of sodium bisulfite in water (1%). At that time the one half green banana 12 is provided and treated with the 1% sodium bisulfite solution. Specifically, the half green banana 12 is placed in a blender 14 with the treatment solution and blended for a predetermined amount of time and preferably for two minutes in order to create a mixture. The mixture is then poured out onto a sieve 16 that in a preferred embodiment is a 200 mesh stainless steel sieve and mashed with a glass stirring rod 18 saving the material going through the sieve 16.

The liquid suspension is then collected and centrifuged with a centrifuge 20 at a moderate speed causing a green material to be on top of the banana starch wherein the green material is discarded. The remaining white banana starch is then washed free of the sodium bisulfite by multiple washings in 95% ethanol.

This identical method was used with a solution of sodium hydroxide instead of sodium bisulfite on the other half of the green banana and it was shown that the sodium bisulfite produced a 13% greater yield than the sodium hydroxide method. Thus, the 1% sodium bisulfite is the more effective solution when attempting to isolate banana starch from green bananas and is effective at removing protein from starch.

Utilizing either sodium bisulfite or sodium hydroxide produces a brown starch after storage for several months. In order to overcome the starch becoming brown after storage for several months, the 1% sodium bisulfite can be suspended and the suspension centrifuged once and not completely dried. This is done because sodium bisulfite solutions are known to be bleaching agents and presents a way to prevent the starch from browning after several months in storage.

What is claimed is:

1. A method of isolating banana starch from a green banana steps comprising:
blending a green banana with a treatment solution for a predetermined amount of time to create a mixture;
pouring the mixture through a sieve;
collecting a liquid suspension of the mixture;
centrifuging the liquid suspension to form white banana starch; and
washing the banana starch with ethanol to isolate the banana starch.

2. The method of claim 1 wherein the ethanol is 95% ethanol.

3. The method of claim 1 wherein the treatment solution comprises a solution of sodium bisulfite in water.

4. The method of claim 3 wherein the solution is 1% sodium bisulfite.

5. The method of claim 1 wherein the predetermined amount of time is two minutes.
